(19) United States
(12) Patent Application Publication
(10) Pub. No.: US 2006/0200406 A1
(43) Pub. Date: Sep. 7, 2006

(54) Seeded loan investment method

(76) Inventor: Douglas Burke, Newport Beach, CA (US)

Correspondence Address: Douglas Burke, 2507 Port Whitby, Newport Beach, CA, 92660, US

(21) Appl. No.: 11/073,838

(22) Filed: Mar. 5, 2005

(51) Int. Cl. G06Q 40/00

(52) U.S. Cl. 705/38

(57) ABSTRACT

A loan investment method comprising a lender providing a loan to a borrower for the purpose of the borrower buying property from a seller wherein:
said sale price for said property being, A, and said loan amount being, A+Xₒ, and
said amount, Xₒ, being seed capital, and greater than zero, and said seller receiving said amount, A, from said lender in exchange for said property, and said lender holding deed to said property, and
said borrower assuming debt in the amount, A+Xₒ, and under the agreement of said loan, said borrower being obligated to make periodic payments to said lender, and, said seed capital, Xₒ, being placed into an investment vehicle managed and controlled by said lender, and
the debt obligation of said borrower being a function of time, t, and being represented as α(t)=A+Xₒ+β(t), and
the value of said investment vehicle being a function of time and being represented as, γ(t)=Xₒ+δ(t), and a time, t*, being such time when, α(t*)=γ(t*) or equivalently when A+β(t*)=δ(t*), and at such time, t*, said lender receiving full ownership of said investment vehicle in satisfaction of the loan, and at such time, t*, said borrower receiving full ownership and title of said property

### FIELD OF THE INVENTION

The proposed invention relates to a method of loan financing. More particularly it provides a means of empowering the borrower to repay the loan in a shorter period of time. A partnership is formed with the lender. An investment seed fortifies the partnership.

### BACKGROUND OF INVENTION

The standard personal, business, or mortgage loans comprise the borrower repaying the lender via monthly payments. The payments include interest on the principal and a portion of each payment is usually allocated towards reducing the principal. The ratio of the amount allocated to interest and principal will vary as a function of time as the repayment schedule progresses. The interest rates may be fixed or may vary. The payments are usually calculated by amortization schedules which are generated from known compound interest formulas.

In purchasing a home, 10 to 25 percent is provided by the borrower and the bank finances the remainder, obtaining a security interest in the house as collateral. If the home buyer defaults on the loan, the bank can resell the house to recover the remaining balance.

Rises of interest rates in the 1970's spawned the Adjustable Rate Mortgage (ARM). These varied the interest rates to shift the risk to the borrower. Some of them would offer lower rates to the borrower at the beginning of the loan but the rates would rise later. The ARM did not really do anything for the buyer to get his mortgage paid off and own his house free and clear in a shorter period.

The Shared Appreciation Mortgage (SAM) arose which offered lowered interest rates to the borrower in exchange for the lender receiving a share in the appreciation of the value of the house. This plan had the borrower giving up a fraction of his ownership, deleting the hope of one day owning the house free and clear.

Various and sundry other techniques have been invented to solve the problem of loan financing. The goal is to increase the security of the lender and at the same time to make it easier for the borrower to repay the loan and claim the property as his own.

U.S. Pat. No. 6,671,677 to May, discloses a method of providing discount points to the borrower which are added to the amount of the loan to reduce the interest rate of the loan. The mortgage insurance is then determined on the smaller loan amount, which is based on the absence of the discount points. This is no great break for the borrower since he will pay for all the illusory benefits over the life of the loan. It does not reduce the time in which the borrower can repay the loan. It does not represent a means to empower the borrower.

U.S. Pat. No. 6,615,187 to Ashenmil et al. discloses a method of scrutinizing real estate brokerage options (REBO). The borrower who is buying the property can sell the future REBO when he sells the property. The money from the REBO can help the borrower buy the property since he can put that money towards his down payment and closing costs. This does not reduce the time required to repay the loan.

U.S. Pat. No. 6,644,726 to Oppenheimer describes a method of implementing a loan wherein the borrower has a Joint Venture Partner (JVP). For example in a mortgage agreement for a home, the homeowner retains the traditional right of use and possession, but immediately surrenders a fixed equity share in the house to a new JVP. With the aid of the JVP the homeowner can have lower monthly payments and can effectively defer some of the payments to termination. The JVP in return for partial financing obtains a substantial and fixed share in the value of the house from inception to termination of the agreement. At the end of the agreement (through sale, normal termination, or foreclosure), the homeowner repays his JVP for his share of the house. The disadvantage to this method is that the homeowner gets to live in the house but does not have the privileges and rights of full ownership.

U.S. Pat. No. 6,345,262 to Madden discloses a system and method of implementing a mortgage plan wherein the lender shares in the appreciation of the mortgage. This sharing in the appreciation allows the lender to give a reduced interest rate. If the appreciation is high enough, the interest rate can be zero. Madden discloses his Shared Appreciation Method (SAM) program which is embedded in a method of using a computer system to implement the foregoing. Oppenheimer in U.S. PAT also reviews the SAM. U.S. Pat. No. 5,644,726. One disadvantage of the SAM is that the lender does not reciprocally share with the homeowner any losses on the value of the house over the mortgage duration.

U.S. PAT. APP. PUB to Madden discloses a SAM, yet further comprising a computer to implement the loan. An interest free scenario is claimed. This lowers the payments for the borrower. However, the lender can't really make good money unless the property is sold. If the borrower never wants to sell the property there is a problem.

U.S. Pat. No. 4,876,648 to Lloyd discloses a method for repaying a mortgage loan where the borrower only makes interest payments on the principal and the lender invests in a life insurance policy on the life of the borrower in order to repay the principal after a 30 year mortgage length. In this method the lender's cost in insuring the life of the borrower is offset by increased interest payments from a higher interest rate. The borrower benefits over the 30 year term as well by taking advantage of the market returns on the life insurance policy to repay the principal and increased tax savings resulting from the tax deductibility of mortgage interest payments. A disadvantage of the system, however, is that the amount of money invested that is receiving market rates of return is limited to the insurance premiums paid by the bank. As well, there is no reduction in the term of the mortgage. This loan does not help the borrower.

U.S. Pat. No. 5,907,828 to Meyer et al. describes a method of providing bank-owned life insurance on the life of the borrower without fees and extra interest charges. Under this method, the bank purchases a mortgage life insurance policy from an insurance company and borrows the maximum amount from the policy and invests the money to earn a greater rate of return. After a certain amount of the cash value of the insurance policy has been loaned to the bank, the bank may make cash withdrawals on the policy in order to support its cash flow requirements. Under this method, the bank reduces its risk and increases its return by having mortgage life insurance on all of its borrowers and not merely those who opt to obtain mortgage life insurance. The borrower saves money by not having to pay interest premium for mortgage insurance. A disadvantage of this system is that the borrower does not benefit from the increased market return.

U.S. Pat. No. 5,673,402 to Ryan et al. describes another method of financing a house purchase. The usual down payment is replaced with an insurance purchase. The insurance purchase is used to purchase a life insurance policy on the life of the borrower payable to the lender to cover the mortgage principal. The borrower then makes regular interest payments on the principal until the cash value of the life insurance policy is sufficient to completely repay the principal of the loan. Under this method, the cash needed by the borrower up front is greatly reduced (from 20 percent to 12 percent of the home purchase price in the example shown in the patent) and the bank has additional security in both the collateral of the home and the life insurance policy. A disadvantage of this system is that, as in the Lloyd method, most of the payments made over the life of the mortgage are interest payments and are not subject to market rates of return in order to reduce the length of the mortgage. This is not a big break for the borrower.

Life insurance is also used to provide security for the lender. Thus if the borrower dies, the lender can get the life insurance money and use it to pay off the loan. U.S. PAT. APP PUB to Jarzmik discloses a method of loan financing employing a life insurance policy. In this regime the borrower provides a down payment and the lender loans the rest of the cost to buy the property (a home for instance). The borrower instead of making loan payments makes roughly equivalent payments towards a life insurance policy, which the lender owns. When the life insurance policy has a value equal to the loan obligation the lender sells it and takes the cash as payment for the loan. Jarzmik gives an example in which a 30-year loan is repaid in 15 years. The disadvantage of this method to the borrower is that he gives up his benefits of having a life insurance policy that will put cash in the hands of his loved ones. The lender gives up receiving the interest on the loan until the life insurance policy (investment vehicle) matures. The monthly payments are received and controlled by the insurance company. During this time the loan obligations accumulate. This must be shown on the lender's books as a liability. It is offset by the value of the investment instrument. Yet the loan is essentially in default until the investment vehicle matures. Yet another disadvantage is that the investment vehicle does not mature in value to repay the loan in a very rapid rate. The speed at which the investment vehicle matures is limited by the fact that it is only receiving monthly payments as cash flow input. There is no principal amount of money replaced in the investment vehicle to seed it thereby allowing it to take root and grow rapidly. Thus the presence of the seed capital is absent in Jarzmik's method. This is a disadvantage. The proposed invention includes the injection of seed capital into an investment vehicle. Where does it come from? The lender gives it to the borrower. That is the unobvious inventive step of the proposed invention. That step is advantageous to both the borrower and lender. It is an advantage and an object of the proposed invention.

U.S. PAT. APP PUB to Berger discloses a reduced interest mortgage payment plan. In this method a mortgage loan is repaid by paying down the principal first. This is not desirable for the lender since over the life of the loan the borrower received less interest. The lender is therefore unlikely to benefit as much as the borrower.

Heretofore there is a need for a business method loan arrangement that empowers the borrower and enables him to satisfy the loan and gain full ownership of the property is a relatively short period of time. In addition to being beneficial to the borrower, the loan needs to be advantageous to the lender in the amount of money that is able to make using the business method. Thus a loan business method that is advantageous to both lender and borrower will enhance the economic vitality of both.

### SUMMARY OF THE INVENTION

The proposed invention is a business method for a lender. The method involves a borrower who needs a loan to buy a property and wants to attain full ownership of the property. The property may be a home. The borrower may have little or no money for a down payment. The method comprises the lender giving the borrower a loan for an amount greater than the cost required by the seller of said property. The excess abundance of the loan amount is then placed into an investment vehicle and managed by the lender. The borrower makes loan payments on the full loan amount. The investment vehicle appreciates until such time that its value equals the remaining obligation of the loan. At that point the lender assumes full interest of said investment vehicle and the borrower assumes full ownership of said property.

It is unobvious that the lender would be more secure by lending more money than the property is worth. This is so because if the borrower defaults the loan, a new borrower can assume the partnership position. Since the method will yield property ownership in a shorter term and without “money down” there will be a demand to attain the partnership position. Another reason the lender has more security is the following. The loan puts cash into the hands of the lender that he invests. The cash is secured by the borrower's payment and accounted for since the interest on it is being paid for by the borrower. This increases the investment leverage of the lender. It further provides a means for the lender to expand its role as an investment manager in the financial markets. It further allows the lender the means to establish lifelong loyal relationships with the borrowers who later become loyal investors. That loyalty coming from the business relationship established wherein they got their home financed and paid for quickly.

Further the Lender has an immediate gain. The method could be thought of in a simple example. The lender buys the property for 100% of its appraised or market value and immediately sells it to the buyer for 120% of said value. In exchange for buying it for above market value the lender takes the excess overabundance of the loan and invests it so it can grow and eventually pay off the loan.

The novelty is that the excess of the overabundance of the loan is used to seed the investment vehicle, invigorating it. Without that seed capital the investment vehicle does not have the future strength to pay off the loan. The borrower is like a small business in which the lender is investing. If the business is not undercapitalized it has a higher probability of success. Thus the lender capitalizes the borrower.

### OBJECTS AND ADVANTAGES

Accordingly the objects and advantages of the proposed invention are:
(1) The borrower is empowered with the money to buy the property and the seed capital to repay the loan.
(2) The lender's security is increased since it is diversified against the future value of the property and the future value of the abundantly seeded investment vehicle
(3) The borrower will eventually obtain full ownership of the property without a partner.
(4) The borrower does not have to give up the future value if his life insurance policy.
(5) If the borrower defaults there will be demand for others to assume the borrower's position. This will increase the value of the lender's foreclosure portfolio since each property will have an investment vehicle attached to it.
(6) Small investors can participate in buying real estate without lard down payments which normally exclude them.
(7) The investment vehicle linked to the loan agreement is seeded with capital giving it the economic momentum to pay off the loan.

### BRIEF DESCRIPTION OF THE DRAWINGS AND TABLES

FIG. 1—A schematic of the time progressive flow of capital in an example embodiment of the invention wherein seed capital is present and borrower makes loan payments on principal and interest.

FIG. 2—A schematic of the time progressive flow of capital in an example embodiment of the invention wherein seed capital is present and borrower makes interest only payments on loan.

FIG. 3—A schematic of the time progressive flow of capital in an example embodiment of the invention wherein seed capital is present and borrower makes payments into the investment vehicle while the debt obligation grows as the loan accumulates interest

Table-1 Maturation values of investment seeds.

### DETAILED DESCRIPTION OF THE INVENTION

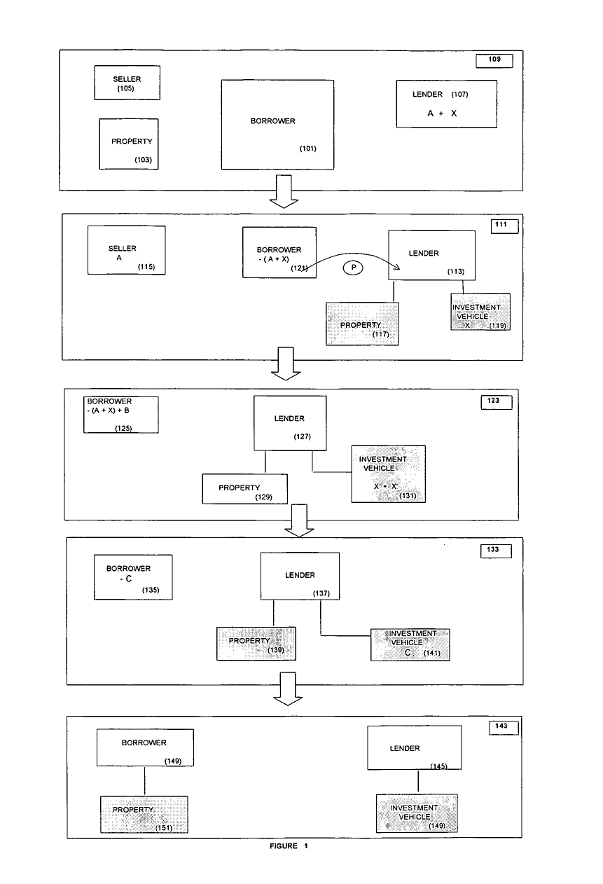

Referring to FIG. 1 a schematic of one of the preferred embodiments of the proposed invention is shown. A borrower, 101, wants to buy the property, 103, for an amount, A, from the seller, 105, of said property. The borrower approaches a lender, 107, who enters into a loan agreement business plan to implement the method wherein the lender allocates an amount of funds, A+X, as shown in the lender's box, 107. This first set of events is shown in the large box, 109. The next sets of events are shown in the box, 111. Time is increasing as you move from the top to bottom in FIG. 1. The loan agreement business/method is set into motion in box, 111. The lender, 113, transfers an amount, A, to the seller, 115, who in turn transfers the property, 117, to the lender. The lender transfers the amount, X, into an investment vehicle, 119. The borrower, 121, is now indebted to the lender by the amount −(A+X), the minus sign is used to indicate that the amount is a debt. The borrower begins making payments, P, to the lender. The next state of affairs some time later is shown in box, 123. The borrower, 125, has reduced his debt to, −(A+X)+B, by making his payments. The value of the investment vehicle, 127, has increased to an amount, X+X¹. The lender, 127, maintains the deed to the property, 129. The seller, at this point, is absent since they were paid in full for their property and they have gone on their merry way. At some particular time later, the state of affairs is shown in box, 133. At this time, the absolute value of the borrower's, 135, debt obligation is equal to, C. Also the value of the investment vehicle, 141, is also equal to, C. The lender, 137, still holds the deed to the property, 139, and he is still managing the investment vehicle, 141. The payments at this point are no longer required. The next state of affairs is immediate and is shown in box, 143. The lender, 145, assumes full ownership of the investment vehicle, 147. The borrower, 149, assumes full ownership of the property, 151.

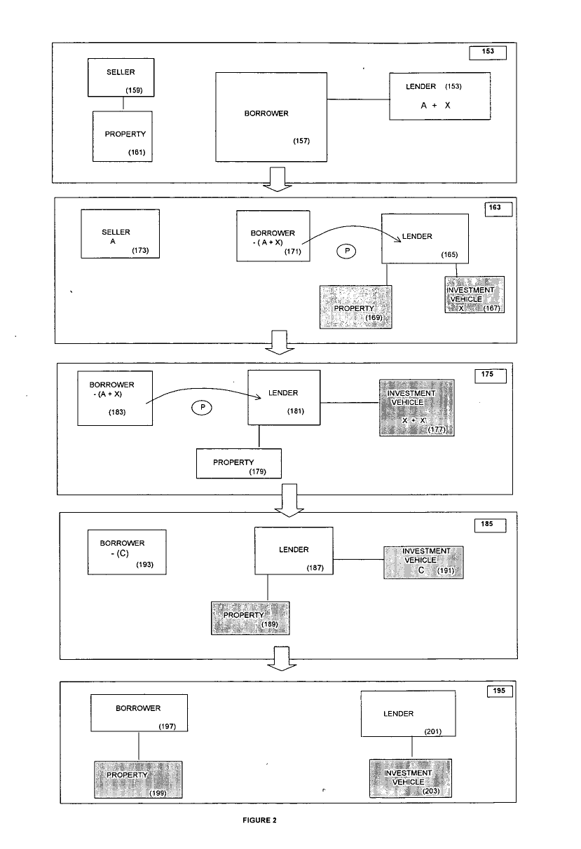

In a second embodiment of the proposed invention, the loan agreement involves the borrower making payments of interest only throughout the course of the agreement. The amount that the borrower owes is held at a constant value, (A+X). The investment vehicle appreciates to a value, X+X¹, when A+X=X+X¹, or equivalently when A=X¹, the exchange is made. The lender assumes ownership of the investment vehicle and the borrower assumes ownership of the property. This interest only loan may take longer to fulfill but the payments will be lower. A schematic of this embodiment is shown in FIG. 2.

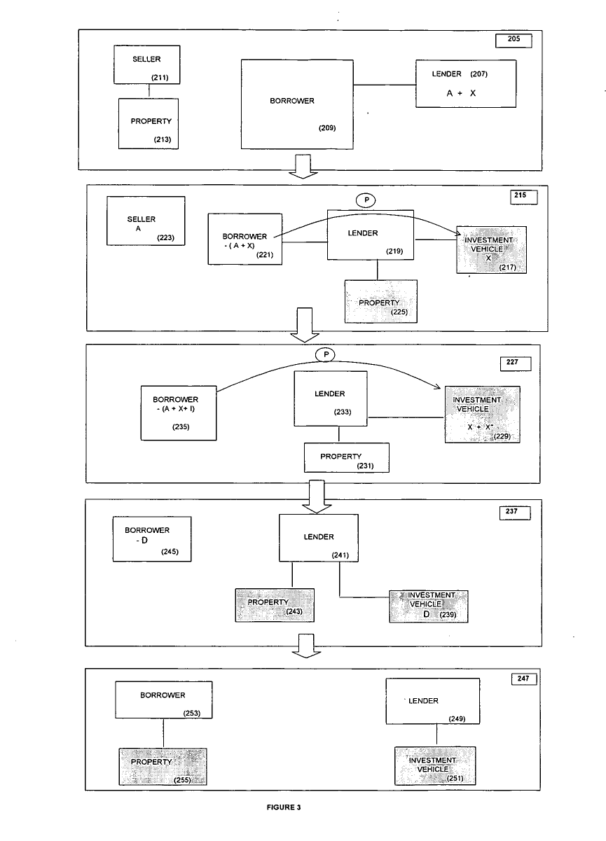

A third embodiment comprises the method of the earlier embodiments but is structured so that there is no interest or payments made to the lender. The borrowed amount, A+X, is allowed to accumulate interest and grow to an amount (A+X+I). The investment vehicle still has the seed capital, X, but the borrower makes payments into the investment vehicle directly which allows it to grow more quickly. This increased growth rate outweighs the accumulated interest, I, on the loan. A schematic of this embodiment is shown in FIG. 3. Referring to FIG. 3, the borrower, 209, approaches a lender, 207, to buy a property, 213, from a seller, 211. The lender, 219, loans an amount, A+X, under an agreement to the borrower, 221, who is now in debt by an amount −(A+X), where the minus sign means the indicated amount is a debt. At the start of the loan the lender, 219, holds the deed to the property, 225, and the borrower makes payments into the investment vehicle, 217. As time progresses the borrower's debt increases to −(A+X+I) and the value of the investment vehicle, 229, increases to, X+X¹¹. When the value of the investment vehicle, 239, is equal to, D, and the borrower's debt, 245, is equal to, −(D), the borrower gets the property, 255, and the lender, 249, takes full control of the investment vehicle, 251.

In another embodiment of the proposed invention any of the earlier embodiments are employed yet the interest is forgiven by the lender. The lender can truly say that he is not charging usury or interest. In this case, the borrower and the lender arrange an agreement wherein the lender can withdraw profit out of the investment vehicle in exchange for the loan that is made in good faith. The borrower makes payments to the lender that go directly towards paying off the loan.

In another embodiment one or a combination of the earlier embodiments are employed. A further inclusion is the feature that the borrower assumes the daily responsibility of managing the investment vehicle. For instance, if the investment vehicle is a stock portfolio the borrower will buy or sell according to a given set of parameters provided by the lender.

In yet another embodiment one or a combination of the first and second embodiments are employed with the further inclusion that the lender provides an adjustable rate mortgage (ARM) to reduce the payments made by the borrower during the early stages of the loan.

In yet another embodiment, one or a combination of the earlier embodiments is employed. A further inclusion is that the lender and borrower share in the appreciation of said property. The SAM feature can be written into the agreement.

In yet another embodiment of the proposed invention, the investing vehicle is a small business owned and operated by the borrower. The seed capital, X, is given to the borrower to start a new business or expand an existing business. The profits, X¹, from the business are placed into an escrow account until they grow to an amount adequate enough to fulfill the loan obligation. At such time the business and the property belong to the borrower. In this embodiment the lender may also receive a share in the ownership of the business by way of stock or other contractual agreements. An additional feature to this embodiment is that the profits, X¹, do not have to be placed into escrow, they can be reinvested into the business to make it grow even more rapidly. Another feature is that as X¹ increases, a portion thereof may be placed into one or more investment vehicles other than the small business.

Another embodiment includes any combination of the earlier embodiments. It further includes refinancing the loan continually. In this embodiment a property is purchased for an amount, A, and a loan is given for an amount, A+X. The seed capital, X, is placed into an investment vehicle. If the property appreciates in value the lender immediately increases the loan amount and places more money into the investment vehicle. This of course will increase the payments of the borrower in some of the embodiments. The borrower needs to be able to handle that. The increased payments can be deferred to later if the borrower cannot handle the payments. Either way the benefits are significant. What this does is increase what we will call the Seed Ratio (SR). The SR is the amount of money put into the investment vehicle by the lender divided by the amount of money owed by the borrower. The higher the SR the quicker the investment vehicle can repay the loan. As an example, imagine a property that has a value, A=100K, and the seed amount at the start of the loan is X=20K. The SR is X divided by A+X which is equal to ⅙. Now lets say one year after the property is purchased, the said property appreciates by an amount 30K. Let's further suppose that the borrower is making interest only payments as described in the second embodiment. This will simplify our calculations. At this point now, the lender will refinance given the appreciated amount and the total amount of the loan will be 150K. The investment vehicle seed is now 50K. The seed ratio becomes 50K divided by 150K which is ⅓. It has doubled. This loan would have a feature called an Adjustable Appreciation Seed Ration (AASR). As appreciation occurs, the SR is automatically increased. There is a strong incentive of the borrower to increase the SR since that will more timely lead to his ultimate goal, owning the property free and clear.

In another embodiment of the proposed invention the borrower makes an additional agreement with the lender. When the borrower has repaid the lender, the borrower gives the lender a gift of the amount, X, the original seed money at the beginning of the loan.

In another embodiment of the proposed invention the borrower is an investment group.

In another embodiment the length of the loan is made as long as possible so as to achieve the lowest possible monthly payment.

A first example involving actual numbers of the operation of the invention is as follows.

A borrower wants to buy a home for 200K=A. The lender lends an amount A+X=200K+40K=240K. 200K buys the house, 40K is placed into an investment vehicle. The future value of the investment vehicle is γ(t)=X e^{rt}. X, is the initial seed value of 40K. r, is the annual interest rate. t, is time in years. This is the formula for continuous compound interest accrual. Now the total debt is allowed to accumulate to a value D(t)=Dₒe^{r}^{_{d}}^{t}. Dₒ, is the initial loan value, 240K. r_{d}, is the interest rate of the loan (debt). t, is the time in years. Now if the borrower makes payments into an annuity as a second investment vehicle it will have a future value given by the formula:

$$F . V . = \frac{P [ {( 1 + {r}_{a} / N )}^{n} - 1 ]}{{r}_{a} / N}$$

In this formula, P=payment per pay period, rₐ=the annual interest rate of the annuity, N=the number of pay periods per year, n=the total number of pay periods, and n=Nt, t is the time in years. Now the parameters are given the following values:
r=interest rate of the investment vehicle into which the initial seed is placed=10%
r_{d}=interest rate of the loan=6%
rₐ=interest rate of the annuity=10%
N=number of annual pay periods per year=12
P=annuity payments=1611 dollars.

When the accumulated debt is equal to the value of the sum of the two investment vehicles, the time is about equal to ten years.
Accumulated debt in ten years=437K (approx)
First investment vehicle value in ten years=110K (approx)
Annuity value in ten years=328K (approx)

A second example of the proposed invention is as follows. The borrower wants to buy the same house for 200K. The lender lends, 240K, providing an initial seed value of 40K. The borrower makes interest only payments on the loan of an amount $1200 per month, for an interest rate of six percent. This keeps the loan healthy and current on the lender's books. The seed is placed into an investment vehicle that has an annual rate of return of ten percent, compounded continuously. The investment vehicle's value will equal the debt value 240K, in approximately 18 years. If the investment vehicle is able to accumulate 18% per year the debt will be paid in ten years. These values are certainly less than the standard 30 year loan.

The foregoing examples illustrate the power of the seed method. The borrower gets the property in a shorter period of time. The lender gets their money back faster and it can be placed into another loan. The money can be lent out three times if it is repaid in one third the time.

Another mode of the proposed invention as mentioned involved the incorporation of the AASR (Adjustable Appreciation Seed Ration). In this mode the initial seed Xₒ, is placed into an investment vehicle at the start of the loan. After the first month the property may appreciate in value by a certain amount, X₁. X₁ is then placed into an investment vehicle. At the end of the second month, if appreciation occurs, a new amount, X₂, is placed into an investment vehicle. Essentially the property is refinanced on a monthly basis. The cash drawn out of it is placed into investment vehicles on a monthly basis. This mode can be thought of as putting a new seed into an investment vehicle every month. The seeds can all be placed into one vehicle or a plurality of vehicles. The total amount of see capital invested divided by the total loan amount is the seed ratio adjusted monthly according to the appreciation of the property. A list of the seed values as a function of time is shown in Table-1. The seeds are here assumed to be accumulating interest at an annual rate, r, compounded continuously. The number of periods per year that a new seed is placed into an investment vehicle is, N. The total number of such periods is, n. The total time in years that the seeds are in play in the vehicles is t=n/N. The seed values that are injected monthly are: {Xₒ, X₁, X₂, . . . Xₙ}. Their respective values as a function of time are: {Sₒ, S₁, S₂, . . . Sₙ}

TABLE 1

Sₒ = Xₒ e^{rt(n-o)/n} = Xₒ e^{r(n/N)}
S₁ = X₁ e^{rt(n-1)/n} = X₁ e^{r(n-1/N)}
S₂ = X₂ e^{rt(n-2)/n} = X₂ e^{r(n-2/N)}
.
.
.
Sⱼ = Xⱼ e^{rt(n-j)/n} = Xⱼ e^{r(n-j/N)}
.
.
.
Sₙ₋₁ = Xₙ₋₁ e^{rt(1/n)} = Xₙ₋₁ e^{r/n}
Sⁿ = Xₙ e^{o} = Xₙ

The total investment vehicle value after n periods is given by:

$$γ ( t ) = γ ( n / N ) = {\sum }_{j = 0}^{n} {X}_{j} {ⅇ}^{r ( n - j ) / N} = {ⅇ}^{r ( n / N )} {\sum }_{j = 0}^{n} {X}_{j} {ⅇ}^{- rj / N}$$

This is a useful formula for N injections per year of seed capital. It is important to remember that this formula assumes that the seeds are placed into vehicles that provide gains of annual interest, r, that is compounded continuously. If we wish to incorporate the value of the property at the start of the loan, A, and annual rate of appreciation of said property, R, the seed values that are injected, Xⱼ, are based on the appreciation of the property. For instance the value of the initial seed is simply Xₒ. To compare the value of the first injected seed after the first period N has passed (where there are N periods per year for instance N could symbolize one month) simply take the appraised value of the property at the start of the loan A and multiply it by the interest R/N where R is the annual rate of appreciation. This gives an investment seed after the first six months of X₁=A (R/N). The values of Xⱼ in the sum of equation (1) can be listed as

$${X}_{o} = {X}_{ o} ( Initial investment seed at the start of the loan ) \\ {X}_{1} = A ( R / N ) \{ 1 \} \\ {X}_{2} = ( A + \frac{AR}{ N} ) \frac{R}{ N} = \frac{AR}{N} \{ 1 + \frac{R}{N} \} \\ {X}_{3} = ( A + \frac{AR}{N} + \frac{{AR}^{2}}{{N}^{2}} ) \frac{R}{N} = \frac{AR}{N} \{ 1 + \frac{R}{N} + \frac{{R}^{2}}{{N}^{2}} \} \\ \begin{matrix}{X}_{4} = ( A + \frac{AR}{N} + \frac{{AR}^{2}}{{N}^{2}} + \frac{{AR}^{3}}{{N}^{3}} ) \frac{R}{N} \\ = \frac{AR}{N} \{ 1 + \frac{R}{N} + \frac{{R}^{2}}{{N}^{2}} + \frac{{R}^{3}}{{N}^{3}} \}\end{matrix} \\ \begin{matrix}{X}_{j} = ( A + \frac{AR}{N} + … + \frac{{AR}^{j - 1}}{{N}^{j - 1}} ) \frac{R}{N} \\ = \frac{AR}{N} \{ 1 + \frac{R}{N} + \frac{{R}^{2}}{{N}^{2}} … \frac{{R}^{ j - 1}}{{N}^{j - 1}} \}\end{matrix} \qquad ( 1 a )$$

The terms in brackets {} are finite geometric series with a common ratio, R/N, and can be easily summed giving:

$${X}_{j} = \frac{AR}{N} \frac{1 - {( R / N )}^{j}}{1 - R / N} \qquad ( 1 b )$$

Taking eqn (1b), replacing the dummy index, j, with, k, and substituting the expression into eqn (1) gives eqn (2):

$$γ ( t ) = γ ( n / N ) = {X}_{o} {ⅇ}^{( nr ) / N} + {\sum }_{k = 1}^{n - 1} \frac{AR}{N} ( \frac{1 - {( R / N )}^{k}}{1 - ( R / N )} ) {ⅇ}^{- r ( n - k ) / N} \qquad ( 2 )$$

The parameters in eqn (2) are defined as:
Xₒ=initial seed at start of loan
R=annual rate of property's appreciation
r=annual rate of return of investment vehicle
A=initial value of property at start of loan
n=total number of injection periods where appreciation is evaluated and new seeds are planted
N=the number of injection periods per year
As the seeds are continuously injected into an investment or a plurality of investment vehicles, the amount of debt is increasing. This is so because all of the seeds are generated by financing the increased equity in the property as it appreciates. The debt is increasing by the same amount that the new investment seed capital is being generated. In fact, if you replace the investment vehicle rate of return, r, with the loan interest rate, [symbol] , in equation (2) you get a formula for the debt accumulation. The value for Xₒ, becomes the initial loan amount (A+Xₒ). The debt function can be written as:

$$\begin{matrix}α ( t ) = α ( n / N ) \\ = ( A + {X}_{o} ) {ⅇ}^{( nR ) / N} + {\sum }_{k = 1}^{n - 1} \frac{AR}{N} ( \frac{1 - {( R / N )}^{k}}{1 - ( R / N )} ) {ⅇ}^{R ( n - k ) / N}\end{matrix} \qquad ( 3 )$$

This is assuming that the interest accumulation is compounded continuously.

In both equations (2) and (3) the factor n/N can be replaced with, t, which is time in years.

As an example of an application of these equations consider the following. Imagine that the borrower borrows (A+Xₒ) to buy a house for an amount, A. The borrower makes zero payments on the loan. To compute the time it takes for the investment vehicle value to equal the obligation of debt, simply set equation (3) equal to equation (2) and solve for the time it takes for these values to become equal. Solving for, n, (number of periods) is equivalent to solving for the time. With this method of injecting investment seeds, say, on a monthly basis, the AASR is always increasing. Even though the debt is increasing as well the time required to repay the loan decreases. Clearly the calculations get more complicated. Nonetheless, the method benefits the lender and the borrower.

Wherever within this specification, specific terms like loan and payments are used, it is understood that these terms apply to repayment of a loan. The interest or usury is charged in the usual manners. One of those manners may be a compound interest amortization schedule. However, the invention is not limited to any particular type of interest agreement that might be reached by borrower and lender.

It is further understood that the word property can be applied to a home dwelling. This is not a limitation of the present invention. The property can be an existing business or stock portfolio. It can even be an intellectual property. The present invention is not limited to any one antecedent to the word property.

It is further understood that the investment vehicle is any financial entity into which capital can be placed for gain.

While particular embodiments have been shown and described, it is apparent, that changes and modifications may be made without departing from the broader scope, and, therefore, the aim in the appended claims is to cover all such changes and modifications as falls in the true spirit of the present invention.

I claim:

1. A loan investment method comprising a lender providing a loan to a borrower for the purpose of the borrower buying property from a seller wherein:
(a) said sale price for said property being, A, and
(b) said loan amount being, A+Xₒ, and
(c) said amount, Xₒ, being seed capital, and greater than zero, and
(d) said seller receiving said amount, A, from said lender in exchange for said property, and said lender holding deed to said property, and
(e) said borrower assuming debt in the amount, A+Xₒ, and under the agreement of said loan, said borrower being obligated to make periodic payments to said lender, and
(f) said seed capital, Xₒ, being placed into an investment vehicle managed and controlled by said lender, and
(g) the debt obligation of said borrower being a function of time, t, and being represented as α(t)=A+Xₒ+β(t), and
(h) the value of said investment vehicle being a function of time and being represented as, γ(t)=Xₒ+δ(t) , and
(i) a time, t*, being such time when, α(t*)=γ(t*) or equivalently when A+β(t*)=δ(t*), and
(j) at such time, t*, said lender receiving full ownership of said investment vehicle in satisfaction of the loan, and
(k) at such time, t*, said borrower receiving full ownership and title of said property

2. The loan investment method of claim one yet further including said borrower holding title of said investment vehicle throughout the term of the loan agreement, and said lender holding title of said property, and at said time, t*, said property being exchanged for said investment vehicle in such manner that the transaction meets the requirements thereby being it defined as a tax free exchange.

3. The loan investment method of claim one yet further including said debt obligation of said borrower being not a function of time but remaining constant and equal to the amount, A+Xₒ, and said periodic payments being interest only.

4. The loan investment method of claim one yet further including said function, β(t), being a decreasing function of time, and the absolute value of said β(t) being less than zero, and said periodic payments being such thus making β(t) a decreasing function of time.

5. The loan investment method of claim one yet further including said periodic payments being paid to said lender and being paid towards principal only, and there being no interest paid on the loan, thus making it an interest free loan, and a portion of said payments being placed into said investment vehicle, said function β(t) being a decreasing function of time, and said time, t*, being such time when A+Xₒ+β(t*)+Y=Xₒ+δ(t*), and said amount, Y, being greater than zero, and said amount Y being predetermined by said lender at the start of said loan, and said amount Y being derived of a portion of the profits of said investment vehicle, and said profits being defined by said function, δ(t).

6. The loan investment method of claim one yet further including, said function, β(t) being a decreasing function of time, and said periodic payments being placed into said investment vehicle thereby making δ(t) a more rapidly increasing function of time, and said debt amount increasing by way of its accumulating unpaid interest.

7. The loan investment method of claim one yet further including the borrower assuming the responsibility of managing said investment vehicle.

8. The loan investment method of claim one yet further including said loan having an interest rate that is a function of time thus making it adjustable and the rules determining such adjustments being set forth by said lender and agreed to by said borrower at the start of such loan agreement, thus β(t) being an increasing or decreasing function of a set of parameters {n₁,n₂, . . . } and said set of parameters selected from the group consisting of prime interest rates, indices characterizing financial markets, or any combination thereof.

9. The loan investment method of claim one yet further including the lender sharing in the appreciation of said property.

10. The loan investment method of claim one yet further including said investment vehicle being a business operated by said borrower.

11. The loan investment method of claim one yet further including said investment vehicle being operated by said borrower and said lender sharing in the appreciation of said business.

12. The loan investment method of claim one yet further including said property being a home dwelling.

13. The loan investment method of claim one yet further including said investment vehicle being operated by said borrower and said property being a building, wherein which said business, operates.

14. The loan investment method of claim one yet further including said investment vehicle being operated by said borrower and said property being a building where said business operates, and said building being where said borrower lives.

15. The loan investment method of claim one yet further including said borrower being an employee of said lender.

16. The loan investment method of claim one yet further including said borrower being an employee of said lender, and said investment vehicle being a business venture of said lender.

17. The loan investment method of claim one yet further including said property appreciating in value, and said lender periodically injecting additional seed capital into said investment vehicle, scaled by said appreciation.

18. The loan investment method of claim one yet further including said property appreciating in value, and said lender periodically injecting additional seed capital into said investment vehicle, scaled by said appreciation, and said periodic payments paid by said borrower being scaled by said appreciation.

19. The loan investment method of claim one yet further including said property appreciating in value, and said lender periodically injecting additional seed capital into said investment vehicle, scaled by said appreciation, and the amount of capital present in said investment vehicle being γ(t)=Xₒ+δ(t), and the amount of debt of said borrower being, α(t)=A+Xₒ+β(t), and a ratio being defined as γ(t) divided by α(t), and said ratio being called the Adjustable Appreciation Seed Ratio (AASR).

20. The loan investment method of claim one yet further including said property appreciating in value, and said lender periodically injecting additional seed capital into said investment vehicle, scaled by said appreciation, and the amount of capital present in said investment vehicle being γ(t)=Xₒ+δ(t), and the amount of debt of said borrower being, α(t)=A+Xₒ+β(t), and a ratio being defined as γ(t) divided by α(t), and said ratio being called the Adjustable Appreciation Seed Ratio (AASR), and further including using the value of the AASR at any time, t, to compute a projected value of t*, and further including the use of projected values of AASR's and t*'s as a business method of attracting potential borrowers.

21. The loan investment method of claim one yet further including a means of continuously appraising the appreciation of the value of said property and continuously increasing the amount of said loan, and continuously placing the increased loan amounts into said investment vehicle, as investment seeds.

22. The loan investment method of claim one wherein said loan amount is A+Xₒ, and Xₒ being the initial investment seed, and α(t)=A+Xₒ+β(t), and γ(t)=Xₒ+δ(t), and, N periods per year said property is refinanced based on appreciation, and after each period the capital wrought from the appreciation and refinancing is injected into said investment vehicle, and said continual refinancing liberating capital that increases the value of γ(t) and α(t) and AASR=γ(t)/α(t), thus increasing by the periodic injections of said capital wrought from the refinancing based on said appreciation.

23. The loan investment method of claim one wherein said loan amount is A+Xₒ, and Xₒ being the initial investment seed, and α(t)=A+Xₒ+β(t), and γ(t)=Xₒ+δ(t), and, N periods per year said property is refinanced based on appreciation, and after each period the capital wrought from the appreciation and refinancing is injected into said investment vehicle, and said continual refinancing liberating capital that increases the value of γ(t) and α(t) and AASR=γ(t)/α(t), thus increasing by the periodic injections of said capital wrought from the refinancing based on said appreciation and the value for time, t, represented in the expressions γ(t), α(t), δ(t), β(t), being also represented by n/N, wherein, n is equal to the total number of periods that have elapsed such that n/N=t, (in years), and, r, being the annual rate of return of said investment vehicle, and [symbol] , being the interest rate of said loan, and, R, being the rate of appreciation of said property, and, δ(t), being a function of r and R, and β(t) being a function of [symbol] and R.

24. The loan investment method of claim one wherein said loan amount is A+Xₒ, and Xₒ being the initial investment seed, and α(t)=A+Xₒ+β(t), and γ(t)=Xₒ+δ(t), and, N periods per year said property is refinanced based on appreciation, and after each period the capital wrought from the appreciation and refinancing is injected into said investment vehicle, and said continual refinancing liberating capital that increases the value of γ(t) and α(t) and AASR=γ(t)/α(t), thus increasing by the periodic injections of said capital wrought from the refinancing based on said appreciation and the value for time, t, represented in the expressions γ(t), α(t), δ(t), β(t), being also represented by n/N, wherein, n is equal to the total number of periods that have elapsed such that n/N=t, (in years), and, r, being the annual rate of return of said investment vehicle, and [symbol] , being the interest rate of said loan, and, R, being the rate of appreciation of said property, and, δ(t), being a function of r and R, and β(t) being a function of [symbol] and R, and r, [symbol] , and R, being adjusted every period.

25. The loan investment method of claim one wherein said loan amount is A+Xₒ, and Xₒ being the initial investment seed, and α(t)=A+Xₒ+β(t), and γ(t)=Xₒ+δ(t), and, N periods per year said property is refinanced based on appreciation, and after each period the capital wrought from the appreciation and refinancing is injected into said investment vehicle, and said continual refinancing liberating capital that increases the value of γ(t) and α(t) and AASR=γ(t)/α(t), thus increasing by the periodic injections of said capital wrought from the refinancing based on said appreciation and the value for time, t, represented in the expressions γ(t), α(t), δ(t), β(t), being also represented by n/N, wherein, n is equal to the total number of periods that have elapsed such that n/N=t, (in years), and, r, being the annual rate of return of said investment vehicle, and [symbol] , being the interest rate of said loan, and, R, being the rate of appreciation of said property, and, δ(t), being a function of r and R, and β(t) being a function of [symbol] and R, and r, [symbol] , and R, being adjusted every period, and, said investment vehicle accumulating growth by a standard annual compound interest formula and the value of said investment vehicle being γ(t) and γ(t) being expressed as
$$γ ( t ) = γ ( n / N ) = {\sum }_{j = 0}^{n} {X}_{j} {ⅇ}^{r ( n - j ) / N} \qquad ( 2 )$$
wherein said Xⱼ are the values of the investment seeds invested into said investment vehicle in the jth period of said loan.

26. The loan investment method of claim one wherein said loan amount is A+Xₒ, and Xₒ being the initial investment seed, and α(t)=A+Xₒ+β(t), and γ(t)=Xₒ+δ(t), and, N periods per year said property is refinanced based on appreciation, and after each period the capital wrought from the appreciation and refinancing is injected into said investment vehicle, and said continual refinancing liberating capital that increases the value of γ(t) and α(t) and AASR=γ(t)/α(t), thus increasing by the periodic injections of said capital wrought from the refinancing based on said appreciation and the value for time, t, represented in the expressions γ(t), α(t), δ(t), β(t), being also represented by n/N, wherein, n is equal to the total number of periods that have elapsed such that n/N=t, (in years), and, r, being the annual rate of return of said investment vehicle, and [symbol] , being the interest rate of said loan, and, R, being the rate of appreciation of said property, and, δ(t), being a function of r and R, and β(t) being a function of [symbol] and R, and r, [symbol] , and R, being adjusted every period, and, said investment vehicle accumulating growth by a standard annual compound interest formula and the value of said investment vehicle being γ(t) and γ(t) being expressed as
$$γ ( t ) = γ ( n / N ) = {X}_{o} {ⅇ}^{nr / N} + {\sum }_{k = 1}^{n - 1} \frac{AR}{N} ( \frac{1 - {( R / N )}^{k}}{1 - ( R / N )} ) {ⅇ}^{- r ( n - k ) / N}$$

27. The loan investment method of claim one wherein said loan amount is A+Xₒ, and Xₒ being the initial investment seed, and α(t)=A+Xₒ+β(t), and γ(t)=Xₒ+δ(t), and, N periods per year said property is refinanced based on appreciation, and after each period the capital wrought from the appreciation and refinancing is injected into said investment vehicle, and said continual refinancing liberating capital that increases the value of γ(t) and α(t) and AASR=γ(t)/α(t), thus increasing by the periodic injections of said capital wrought from the refinancing based on said appreciation and the value for time, t, represented in the expressions γ(t), α(t), δ(t), β(t), being also represented by n/N, wherein, n is equal to the total number of periods that have elapsed such that n/N=t, (in years), and, r, being the annual rate of return of said investment vehicle, and [symbol] , being the interest rate of said loan, and, R, being the rate of appreciation of said property, and, δ(t), being a function of r and R, and β(t) being a function of [symbol] and R, and r, [symbol] , and R, being adjusted every period, and, said investment vehicle accumulating growth by a standard annual compound interest formula and the value of said investment vehicle being γ(t) and γ(t) being expressed as
$$γ ( t ) = γ ( n / N ) = {X}_{o} {ⅇ}^{( nr ) / N} + {\sum }_{k = 1}^{n - 1} \frac{AR}{N} ( \frac{1 - {( R / N )}^{k}}{1 - ( R / N )} ) {ⅇ}^{- r ( n - k ) / N}$$
and the accumulation of said debt being given by:
$$\begin{matrix}α ( t ) = α ( n / N ) \\ = ( A + {X}_{o} ) {ⅇ}^{( nR ) / N} + {\sum }_{k = 1}^{n - 1} \frac{AR}{N} ( \frac{1 - {( R / N )}^{k}}{1 - ( R / N )} ) {ⅇ}^{R ( n - k ) / N}\end{matrix}$$

28. The loan investment method of claim one wherein a plurality of buyers are buying a plurality of properties, and each buyer invests their respective investment seeds into a portfolio configuration established as a partnership, this giving each individual buyer the benefit of economics of scale in engaging in trades, buys, sells, in the different investment markets.

29. The loan investment method of claim one wherein a plurality of buyers are buying a plurality of properties, and each buyer invests their respective investment seeds into a portfolio configuration established as a partnership, this giving each individual buyer the benefit of economics of scale in engaging in trades, buys, sells, in the different investment markets, and said partnership being comprised of a plurality of partners, and each partner being one of a plurality of funds.

30. The loan investment method of claim one wherein a plurality of buyers are buying a plurality of properties, and each buyer invests their respective investment seeds into a portfolio configuration established as a partnership, this giving each individual buyer the benefit of economics of scale in engaging in trades, buys, sells, in the different investment markets, and said partnership further includes the aggregation of said properties into a single real estate investment trust (REIT), thus giving said, REIT, an independent identity with independent borrowing and investment power.

31. The loan investment method of claim one wherein a plurality of buyers are buying a plurality of properties, and each buyer invests their respective investment seeds into a portfolio configuration established as a partnership, this giving each individual buyer the benefit of economics of scale in engaging in trades, buys, sells, in the different investment markets, and said partnership further includes the aggregation of said properties into a single real estate investment trust (REIT), thus giving said, REIT, an independent identity with independent borrowing and investment power, and each buyer receiving full title to their respective property when the value of their respective seeds' contribution to said partnership equals the obligation of their respective loan.
